(19) United States
(12) Patent Application Publication
(10) Pub. No.: US 2006/0265946 A1
(43) Pub. Date: Nov. 30, 2006

(54) Electronic communication device with multiple electrodes to electrocute noxious plants

(75) Inventors: Constantino Augusto Henrique Schwager, Sao Paulo - SP (BR); Jeancarlo Ricardo Schwager, Sao Paulo - SP (BR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Sayyou Brasil Industria E Comercio Ltda., Pratania - SP (BR)

(21) Appl. No.: 11/436,856

(22) Filed: May 18, 2006

(30) Foreign Application Priority Data
May 30, 2005 (BR) PI 0502291-6

(51) Int. Cl. A01M 21/04

(52) U.S. Cl. 47/1.3

(57) ABSTRACT

Electronic commutation device with multiple electrodes to electrocute noxious plants”, the present invention refers to an electro mechanic device, generator of electric discharges to eradicate noxious weeds by using an electrode subdivided into smaller electrodes, called multiple electrodes, whereas each multiple electrode is fed by a tension between 1,000 and 35,000 volts, by an electronic commutation system that alternates periods of conduction and cut of electric energy supply for each multiple electrode, lasting between 0.01 and 2.0 seconds; the invention consists of the fact that this system to feed multiple electrodes (7) reduces the number of plants that receive the electric discharge simultaneously and consequently the required power to be supplied by the generator is reduced, significantly improving the yield of the electrocution process; the electric energy in direct or alternating current, coming from a corresponding tension elevator transformer (4) and corresponding current rectifier (5) is supplied by an electric-electronic distributor (3) which is fed by a generator (2) in low tension; another important feature consists of the fact that the type of construction eliminates the formation of electric arcs that cause fires, by appropriately choosing the periods of conduction and cut of electric energy coming from the electric-electronic distributor (3) and supplied to the multiple electrodes (7).

### FIELD OF THE INVENTION

The present invention refers to an electromechanical device that generates electric discharges to eradicate noxious weeds, using multiple fractioned electrodes which, by means of an electronic commutation system, apply medium and/or high tension to noxious weeds; more particularly, it refers to electric equipment provided with an electric-electronic distributor that controls the periods when each multiple electrode is with tension (conduction period) or without tension (cut period), substantially improving the yield and the profit of the electrocution process, and also preventing the formation of voltaic arcs.

### BACKGROUND

Despite all pressures to reduce the consumption of herbicides, toxic products that are harmful to human and animal life, herbicides are still widely used in agriculture to eliminate noxious weeds for their low cost and high effectiveness.

The use of electromechanical equipment to eradicate noxious weeds by electric discharges is a well-known process. However, it has not become an economically viable alternative due to its low electrical yield and high investment, since it requires the construction of expensive, powerful equipment to clean relatively small areas. The use of equipment to electrocute noxious weeds has been then restricted to organic crops, where the use of herbicides is forbidden and labor to clean the area is very costly.

Although organic cultivation has increased substantially lately, it still represents a small portion of the total exploited crop areas, and a small potential market. Thus the construction of said conventional equipment to benefit from its cost reduction due to the possible gains with large-scale production is impractical.

The application of electricity to control noxious weeds in agriculture was more intensively developed, after the First and Second World Wars (Buret, W. E. 1928, Opp, F. W.; Collins, W. C. 1935, Opp, F. W. 1952, Poyor, R. R. 1954). The agricultural use of soil treatment by means of alternating tension (Laronze 1982) or direct high tension (Krause 1975), applied to electrodes in contact with it, was also suggested.

In searches carried on the Brazilian Patent and Trademark Office—INPI—database, we verified the existence of many patent documents for equipment and/or processes that use electricity to eradicate noxious weeds. Most of them have very high costs. The focus of the analysis of the documents found was how electric energy is transferred to the plant to be eradicated; i.e., how the electrodes are built, since the object of the present invention is exactly their enhancement and their performance.

Some of these patents refer to the use of electricity to burn the aerial part of the plants by air or another intermediate fluid heated by an electrical resistance as in French patent FR 9714315 of May 21, 1999 and the Canadian patent 1196.318 of Nov. 5, 1985. Other patents propose the use of electricity in microwave form to manually eradicate weeds, such as Brazilian patent MU 7700561-9 of Jan. 12, 1998 and the U.S. Pat. No. 1,419,429 of Jun. 13, 1922. Patent WO 98/07314 of Feb. 26, 1998, proposes the application of high-tension electric pulses by two discs that cut the soil in order to destroy the weed seeds.

There are other patents that suggest the direct use of electric energy to eradicate noxious weeds by electrocution using electrodes built in a many different ways. The analysis of said patents focused especially on how the electric energy is transmitted to the plant.

Therefore, French patent FR 800477 of Jul. 17, 1981, and U.S. Pat. No. 4,198,781 of Apr. 22, 1980, present the use of electrical conductor liquids to humidify plant stems and leaves to facilitate the contact between the electrode and the plant. In the same fashion, German patent 2328705 of Jan. 2, 1975 states that, with tensions between 10 and 200 V, noxious weeds may be eradicated by roll, disc or tip electrodes, if the plants are humidified by an electrical-conductor liquid. Brazilian patent PI 8403451 of Jun. 25, 1985 also proposes the use of a conductor liquid to facilitate the electrocution of noxious weeds.

U.S. Pat. No. 4,257,190 of Mar. 24, 1981, and its European extension 0027440 of Apr. 22, 1981, refer to electrodes specifically built to eradicate noxious weeds in aisles of non permanent crops.

Some other patents that use high tension to eradicate noxious weeds by electrocution may also be mentioned, as follows:
U.S. Pat. No. 5,806,294 of Sep. 15, 1998, that describes portable equipment where the cutting blade is the electrode itself;
European patent: 0026248 of Apr. 8, 1981, that suggests the use of electrocution on railroad beds;
French patent: 8016340 of Jan. 29, 1982, complemented by its certificates of addition 8100264 of Jul. 16, 1982 and 8022996 of Apr. 30, 1982, describe the use of metal carpet and earth disk-type electrodes;
Brazilian patents: PI 8505970 of Jun. 16, 1987, that describes the use of an aerial electrode and an earth disk and patent PI 9203620 of Dec. 24, 1996, that uses two aerial electrodes for electrocution.

All the mentioned patents use low, medium or high tension, and equally propose the use of electrically fed electrodes simultaneously, and thus require that the electrocuting equipment be designed to supply the necessary electric current to eradicate all noxious weeds in contact with such electrodes. Feeding the electrodes this way requires the use of powerful electric equipment with high cost and high-energy consumption. We should stress that, despite the experimental effectiveness of the devices, their use in agriculture is not economically possible.

In all applications that use high tension directly applied to electrodes positioned at a given distance from the soil, depending on the local conditions of the soil, air and plants, electric arcs form between the electrodes and the earth. Besides causing loss of energy, since they do not pass through plant stems, they represent a permanent risk of fire when dry organic material is present. Brazilian patent PI 9305305 of Dec. 24, 1996, describes a petticoat insulator partially anaerobic created by the insufflation of exhaustion gases, poor in oxygen, from the diesel motor that drives the tractor and electric generator. This method, theoretically valid to extinguish fires, makes the construction of the insulator and its connection to the diesel engine extremely complex and expensive, and reduces the power of the diesel engine by the restriction in the exhaustion. This system does not prevent the formation of electric arcs, which are the primary cause of fire, but only partially extinguishes already started fires, under certain conditions.

It can be seen that the applicant has made exhaustive research on the INPI patent databank and, after careful analysis of almost two hundred documents, concluded that all patent documents found propose to electrocute plants by applying electricity by means of fully fed electrode(s), requiring very high electric currents, overloading the electric generator and making the electrocution process too expensive. The applicant has also verified that only one patent mentions the fire extinguishing equipment to deal with fires that occur during the electrocution process, but only acting after the fires have been formed.

Brazilian patent PI 0201565 of Nov. 6, 2002, filed by the same applicant, solved the problem of high currents to be supplied by the generator when one single electrode is fed by high tension. For that purpose, said document proposed the use of an electrode made of minielectrodes, constituted of small metal elements, which move in all directions, enlarging their operation field of activity in the electrocution process.

The ingenious way of using a minielectrode that touches fewer plants simultaneously, and consequently requires less electric current for each level of high tension, allows a broader area where the electrocution process of noxious weeds is applied, due to its movements. However, in field tests, the equipment presented constructive problems regarding the connections between the moving parts of the minielectrode and the high-tension feeding system. Due to the formation of electric arcs between the moving parts and the fixed parts, these connections are quickly destroyed.

Another problem presented in field tests was the low energy yield since, besides the energy for the electrocution, it is also necessary to supply energy for the mechanical movements of the minielectrodes in the mass of noxious weeds to be eradicated, and fulfill the losses caused by electric arcs formed between the minielectrodes and the ground.

Thus, as explained above, although the application of minielectrodes for the electrocution of noxious weeds is ingenious, field tests showed that the use of this equipment so far is economically unfeasible. The result was the search of a new technology that would allow us to reproduce the same effect of “fewer plants simultaneously touched by the electrodes under tension”, without mechanical movement.

### SUMMARY

To solve the problems and inconveniences of the electrodes described in the patents mentioned in the state of the art, and also to use the same principle of reduction of the number of plants simultaneously electrocuted, as proposed in the previous application by the same applicant, but with no mechanical movement, the present application proposes an electronic commutation device for multiple or fractioned electrodes to electrocute noxious weeds; the device, besides reducing the operational costs of medium and/or high tension to eradicate noxious weeds, and allowing us to visualize the future elimination of herbicides, also eliminates the risk of fire, inherent to electrocution processes; said multiple or fractioned electrodes are assembled in the equipment in a fixed position and, since they are electrified only in the conduction periods, by an electric-electronic distributor, the number of electrocuted plants by each multiple electrode is reduced and consequently the power of the electric generator is also reduced, simultaneously eliminating electric arcs.

The present invention, as opposed to electrocution equipment currently on the market and in the state of the art, allows the use of much less powerful electric generators and therefore electrocutes noxious weeds with low energy consumption. This is achieved by fractioning the electrode, so that it continues to cover the whole area to be electrocuted; said fractioning results in several smaller electrodes, electrically insulated from one another, fed with high and/or medium tension, independently from one another. This way, the electric current is reduced to the required level to eradicate noxious weeds in contact with one single multiple or fractioned electrode.

The commutation between the conduction period and the cut period for each multiple electrode is defined so that each plant is touched at least once during its translation movement. An electric-electronic distributor, which is an integral part of the present application, makes such commutation.

None of the documents found in the state of the art or on the market propose electrocution made by multiple electrodes or fractioned electrodes, such as mentioned in the brief description above.

On the other hand, the present invention prevents the formation of electric arcs, reducing air ionization in the area of activity of medium and/or high tension, limited to the period of conduction and also quickly extinguishes, during the cut period, the few arcs that may have formed, making the energy released by them less than the required one to start a fire.

Thus, the enhancements introduced in the equipment, which will be better explained below, allow noxious weeds to be economically and competitively electrocuted, with no risk of fire, in comparison with processes that use health harmful herbicides.

### BRIEF DESCRIPTION OF THE DRAWINGS

To complement the present description and for a better understanding of the features of the present invention, a set of figures is presented adopting a preferential practical embodiment where the object of the present application is schematically represented as an example but in a non limitative way, as follows:

FIG. 1 shows the state of the art found in patent documents, where a single or three-phase low tension (LT) power source (a) is shown, feeding a transformer (TR) increasing tension to high (HT) or medium (MT) tension that supplies one single electrode (E1) that simultaneously touches all plants (P); we can notice that, in this case, there is a voltaic arc (A) because of air ionization between the electrode and the soil;

FIG. 2 represents, by the same symbolic scheme, patent application PI 0201565 by the same applicant, where a power supply (a) with single or three-phase (BT) low tension is shown, feeding a transformer (TR) increasing tension to high (HT) or medium (MT) tension feeding a minielectrode (E2) provided with mechanical movement of vibration, rotation or others, simultaneously touching fewer plants (P) but reaching the same previous number, due to its movements; we can notice that, in this case, there is also a voltaic arc (A) because of air ionization between the electrode and the ground;

FIG. 3 shows the present invention by the same symbolic scheme, where the equipment is now assembled with a low tension (LT) power supply or generator (2) that feeds an electric-electronic distributor (3) that distributes in low tension and cyclically, energy for tension elevator transformers (4) which individually feed in high and/or medium tension (HT/MT) each one of the multiple or fractioned electrodes (7), which can may be in any number; as we can see, the time for ionization is limited to the conduction period, reducing voltaic arcs to a minimum and the ones which may still form will be extinguished during the cut period;

FIG. 4 shows details of the construction of the equipment, where an internal-combustion engine (1) drives, directly or by the power takeoff of the tractor, single or three-phase low tension electric generator (2), feeding an electric-electronic distributor (3) that allows the transmission of low tension to each of its various outlets, each one connected, to a tension elevator transformer (4) that supplies electric energy in medium and/or high tension by a connection (6), individually, to each multiple or fractioned electrode (7), having the current been transformed into direct current or not by a current rectifier (5), and the electric circuit is closed by the soil (8) and by the earth disk (9);

FIG. 5 shows a constructive variation where the electric energy of each multiple or fractioned electrode (7), transformed into direct current or not by a current rectifier (5), closes the electric circuit by the soil (8) and by the aerial electrode (10);

FIG. 6 shows, in a non limitative way, several examples of an electrode constituted of 2 (two) or more multiple or fractioned electrodes (7) that may have different shapes, such as a comb (11), bar (12), plate (13), assembled wire (14) or any others, each one connected to its source of high/medium tension by the connection (6).

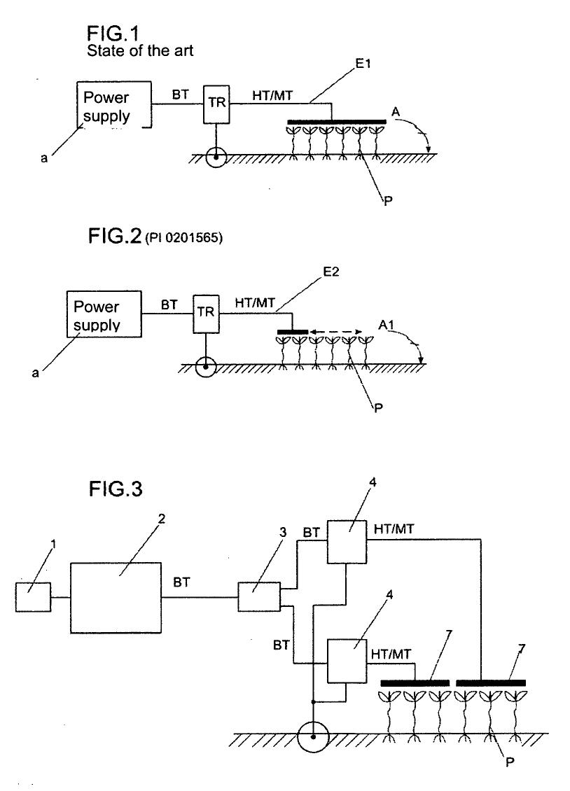

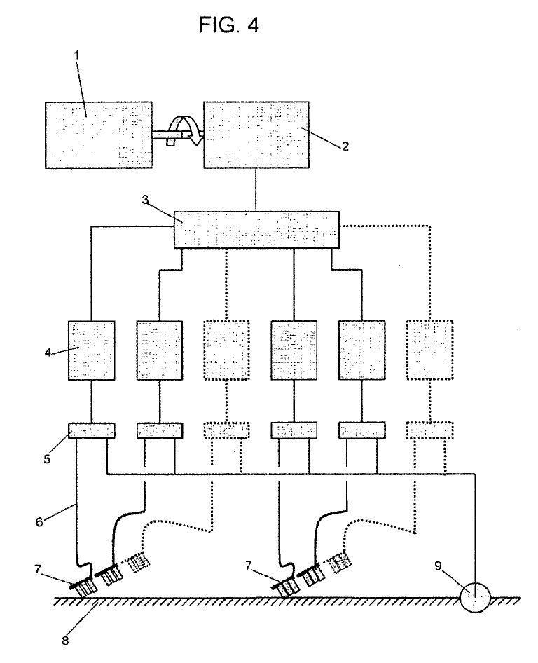

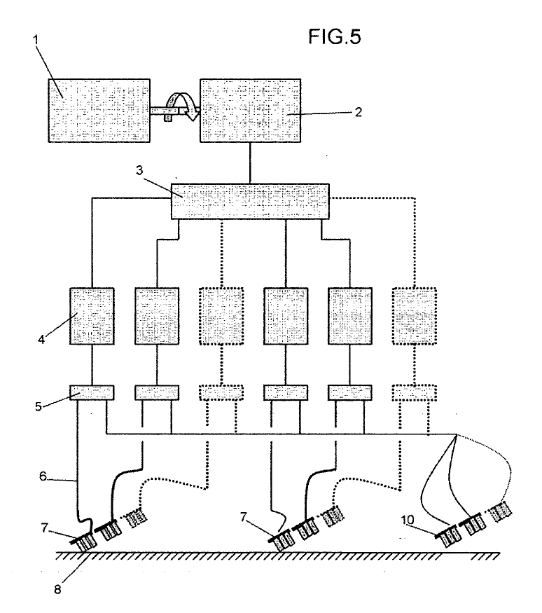

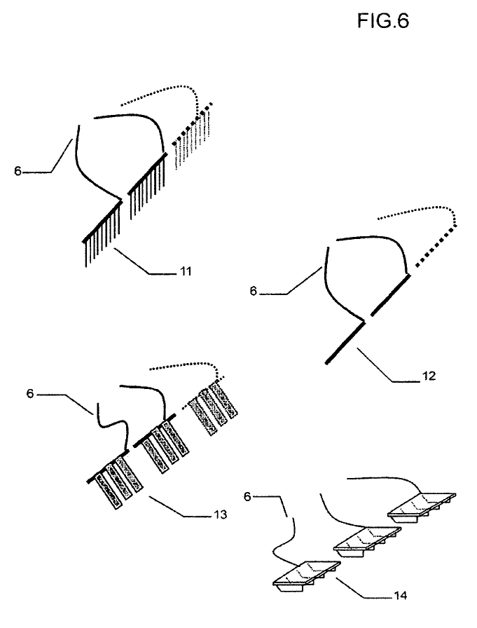

### DETAILED DESCRIPTION OF THE PREFERRED EMBODIMENTS

The present invention refers to an “Electronic commutation device with multiple electrodes to electrocute noxious plants”, electromechanical equipment generator of electric discharges to eradicate noxious weeds, where the electric energy is transferred to the plant to be eradicated by multiple or fractioned electrodes (7).

According to the present invention, the equipment is composed of an internal-combustion engine (1) that drives, directly or by a power takeoff of a tractor, a single or three-phase low tension electric generator (2), with frequency between 10 and 240 cycles per second, feeding in low tension an electric-electronic distributor (3) that commutates/alternates periods of energy conduction with periods of cut of energy in variation between 0.01 and 2.0 seconds at each of its outlets; said distributor transmits energy to each one of its various outlets, being these outlets connected to a tension elevator transformer (4) that raises the tension supplied by the distributor (3) to 1,000 up to 35,000 volts, to supply electric energy in medium and/or high tension, transformed or not, into direct current by a rectifier (5), to each multiple or fractioned electrode (7), of comb (11), bar (12), plate (13), assembled wire (14) or other appropriate type, by a connection (6); the electric circuit is closed in the ground (8) both by the earth disk (9) and by the aerial electrode (10).

To better understand the invention object of this document and its importance in the process of electrocution of noxious weeds, we compare below two different situations working with and without multiple or fractioned electrodes.

In an orange crop, used as an example below, we propose the application of electrocution in a 2.0 meter {m} band in an area infested with noxious weeds which, due to their type and density, require the application of 25 kilowatts {kW} per meter of width of electrode, to assure that each plant receives an electric discharge with enough energy to kill it.

Case 1 (state of the art): Using one single 2.0 meter {m} electrode, fed by one single transformer, the required power of the electric equipment is, in this case, 50 kW {2.0 m×25 kW/m} and the consumption of diesel for the electrocution is of 14 l/h. Adding the diesel consumption of 5 l/h required to drive the tractor with the electrocuting equipment, we obtain, for Case 1, a total consumption of 19 l/h of diesel. The required power for electrocution, 50 kW, plus the displacement power of the tractor and the electrocuting equipment of 18 kW, implies that the tractor should have a diesel engine of at least 68 kW. Since crops of orange, general citrus, coffee, apple and others of the same size normally use tractors of up to 55 kW, an additional diesel engine (1) will have to be installed only to drive the generator (2), thus increasing the investment in about 50%.

Case 2 (novelty): In this case, at least two multiple electrodes (7), of the comb (11), bar (12), plate (13) or assembled wire (14) type, each one measuring 1.0 meter, fed by two independent transformers (4), connected to the generator (2) by an electric-mechanical distributor (3), set for a multiple electrode (7) to be under tension (conduction period), while the other multiple electrode (7) is under no tension (cut period); the total cycle of these two periods, with tension and without tension, is such that each plant receives at least one electric discharge depending on the speed of the horizontal displacement of the multiple electrodes (7); the period of electricity conduction is also set so that there is no time for air ionization to occur between the energized multiple electrodes (7) and the ground, thus avoiding the consequent formation of voltaic arcs between these two points; the cut period extinguishes the arcs that may have formed.

We have experimentally verified that, to achieve the same quality of eradication of noxious weeds as in case 1, we need to increase the power applied to the electrodes by 30%, reaching 32.5 kW/m of electrode, but only one multiple electrode (7) will be simultaneously fed by the electric-electronic distributor (3). Using a 1.0 meter {m} multiple electrode (7), fed by one single transformer, the required power of the electric equipment is, in this case, 32.5 kW {1.0 m×32.5 kW/m} and the consumption of diesel for the electrocution is of 9.1 l/h. Adding the diesel consumption of 5 l/h required to move the tractor with the electrocuting equipment, we obtain, for Case 2, the total consumption of 14.1 l/h of diesel. The required power for electrocution, 32.5 kW, plus the displacement power of the tractor and the electrocuting equipment of 18 kW, implies that the tractor should have a diesel engine of at least 50.5 kW, which is appropriate for the tractors normally used in general crops, making the installation of an additional diesel engine to drive the generator (2), as in case 1 previously shown, completely unnecessary.

As we can conclude from the analysis of the cases presented above, the use of electronic commutation equipment to feed multiple or fractioned electrodes (7) reduces the required power of the electrocution equipment, the diesel consumption and the investment.

Another advantage of the equipment in Case 2 is that the risk of fire is also eliminated, first avoiding the ionization of the air that is between the electrodes and the earth, by limiting the duration of the period of conduction of the electric-electronic distributor (3) and reducing the possibility of occurrence of electric arcs; second, extinguishing, during the period of non-conduction (cut) of the same electric-electronic distributor (3), each and every arc that may have formed.

The use of the present innovated equipment substantially reduces costs and risks that currently bar the efficient substitution of herbicides by the electrocution process.

The present invention does not limit its application to the details and stages described herein. The present invention may have other embodiments and may be practiced or executed in a variety of ways. It is understood that the terminology used has the purpose of description and not limitation.

1. Electronic commutation device with multiple electrodes to electrocute noxious plants, equipment of the electric discharge generator type, designed to eradicate noxious plants, where the electric energy is transferred to the plant to be eradicated through electrodes;
said electro mechanic equipment is composed of a
low tension electric generator (2),
a tension elevator transformer (4) that supplies electric energy in medium/high tension, transformed or not into direct current by a rectifier (5) to electrode to eradicate noxious plants (P);
characterized by the fact that the device has tension elevator transformers (4) fed by at least one electric-electronic distributor (3) in low tension, which commutates/alternates the supply of energy to each one of its various outlets, controlling the periods when each multiple electrode (7) should be under tension (conduction period) or under no tension (cut period).

2. Electronic commutation device, according of claim 1, characterized by the fact that the conduction and cut periods may be determined by the electric-electronic distributor (3) independently for each one of the multiple electrodes (7).

3. Electronic commutation device, according to claim 1, characterized by the fact that electric-electronic distributor (3) establishes a time adjustment between 0.01 and 2.0 seconds for the conduction and cut periods of individual energy of the multiple electrodes (7).

4. Electronic commutation device, according to claim 1, characterized by the fact that when the tension elevator transformers (4) receive low tension energy coming from the electric-electronic distributor (3) they raise said low tension to 1,000 up to 35,000 volts.

5. Electronic commutation device, according to claim 1, characterized by the electric-electronic distributor (3) being located after the electric generator (2) and before the tension elevator transformer (4).

6. Electronic commutation device, according to claim 1, characterized by the fact that the multiple electrodes (7) are formed by two or more electrodes, which are assembled electrically insulated from one another, and can have any shape or dimension.

7. Electronic commutation device, according to claim 1, characterized by the fact that the multiple electrodes (7) are placed in parallel, perpendicular or oblique way in relation to their translation movement.

8. Electronic commutation device, according to claim 1, characterized by the fact that the multiple electrodes (7) are placed adjacent to each other, with the total width of all multiple electrodes (7) defined by the type of crop.

9. Electronic commutation device, according to claim 1, characterized by the fact that the multiple electrodes (7) are placed away from each other with spacing between them defined by the type of crop.

10. Electronic commutation device, according to claim 1, characterized by the fact that the multiple electrodes (7), fed in medium/high tension, close the electric circuit with the earth disk (9).

11. Electronic commutation device, according to claim 1, characterized by the fact that the multiple electrodes (7), fed in medium/high tension, close the electric circuit with the aerial electrode (10).
